(19) United States
(12) Patent Application Publication
(10) Pub. No.: US 2010/0211544 A1
(43) Pub. Date: Aug. 19, 2010

(54) SYSTEM WITH SESSION SYNCHRONIZATION

(76) Inventors: JyShyang CHEN, Cupertino, CA (US); Hui YANG, Wuhan (CN); Yu ZHAO, Wuhan (CN)

Correspondence Address: PATENT PROSECUTION;O2MIRCO , INC., 3118 PATRICK HENRY DRIVE, SANTA CLARA, CA, 95054, US

(21) Appl. No.: 12/703,987

(22) Filed: Feb. 11, 2010

Related U.S. Application Data
(60) Provisional application No. 61/208,016, filed on Feb. 19, 2009.

(51) Int. Cl. G06F 17/30; G06F 15/16

(52) U.S. Cl. 707/622; 709/228; 709/248; 707/E17.044; 707/E17.005; 707/E17.032

(57) ABSTRACT

A computer-readable medium having computer-executable modules is disclosed. The computer-executable modules include a first session database for storing multiple sessions indicating information interchange between at least two communicating devices. The computer-executable modules further include a controller operable for selecting a session from the first session database according to a session update rate indicating the number of sessions updated in the first session database during a given period of time and for synchronizing the session from the first session database to a second session database.

### RELATED APPLICATION

This application claims priority to U.S. Provisional Application No. 61/208,016, entitled “A Master-Backup Firewall System with Dynamic Session Synchronization”, filed on Feb. 19, 2009, which is hereby incorporated by reference in its entirety.

### BACKGROUND

A firewall is an integrated collection of security measures designed to prevent unauthorized electronic access to a networked computer system. It is also a device or set of devices configured to permit, deny, encrypt, decrypt, or proxy all computer traffic between different security domains based upon a set of rules and other criteria. A master-backup firewall system, e.g., a high availability firewall system, can include a master firewall and a backup firewall, to improve availability and stability. When the master-backup firewall system starts up, the master firewall can be enabled to provide firewall functions. The state tables of the master firewall can be replicated onto the backup firewall, which is called session synchronization. Upon a failure or abnormal termination of the master firewall, the master-backup firewall system can automatically offload tasks from the master firewall to the backup firewall and enable the backup firewall to provide the firewall functions instead of the master firewall.

Conventional master-backup firewall systems include at least two solutions for the session synchronization. The first solution is to synchronize all sessions from the master firewall to the backup firewall when the master-backup firewall system is in operation. A second solution is only to synchronize some essential sessions but not to synchronize other sessions when the master-backup firewall system is in operation. However, for the first solution, when a session update rate is faster than the session synchronization rate, the session synchronization may affect the performance of the master-backup firewall system and some essential sessions may not be synchronized to the backup firewall. For the second solution, when the session update rate is relatively low, redundant resources may be wasted after synchronizing some sessions. Thus, the session synchronization may have a lower efficiency.

### SUMMARY

A computer-readable medium having computer-executable modules is disclosed. The computer-executable modules include a first session database for storing multiple sessions indicating information interchange between at least two communicating devices. The computer-executable modules further include a controller operable for selecting a session from the first session database according to a session update rate indicating the number of sessions updated in the first session database during a given period of time and for synchronizing the session from the first session database to a second session database.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1A illustrates an example for a block diagram of a system with dynamic session synchronization, in accordance with one embodiment of the present invention.

FIG. 1B shows examples of the session tables in a session database and the sessions stored in the session tables, in accordance with one embodiment of the present invention.

FIG. 2 illustrates an example for a block diagram of a master-backup firewall system with dynamic session synchronization, in accordance with one embodiment of the present invention.

FIG. 3 illustrates a flowchart of a method for building-up and update sessions in a session database, in accordance with one embodiment of the present invention.

FIG. 4 illustrates a flowchart of a method for synchronizing sessions from a first session database to a second session database, in accordance with one embodiment of the present invention.

FIG. 5 illustrates a flowchart of a method for synchronizing sessions from a master firewall to a backup firewall in a master-backup firewall system, in accordance with one embodiment of the present invention.

### DETAILED DESCRIPTION

Reference will now be made in detail to the embodiments of the present invention. While the invention will be described in conjunction with the embodiments, it will be understood that they are not intended to limit the invention to these embodiments. On the contrary, the invention is intended to cover alternatives, modifications and equivalents, which may be included within the spirit and scope of the invention.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise, the following discussions refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

By way of example, and not limitation, computer-usable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information.

Communication media can embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above should also be included within the scope of computer-readable media.

A network system with dynamic session synchronization is disclosed. The network system can include a first network device functioning as a master and a second network device functioning as a backup of the first network device, in one embodiment. For example, the network system can be a master-backup firewall system including a master firewall and a backup firewall. The first network device can include a first session database for storing various types of sessions for providing interactive information exchange between the first network device and other network devices, e.g., a computer or a router in a network. The second network device functioning as the backup of the first network device includes a second session database to backup the sessions from the first session database of the first network device. In one embodiment, a session synchronization controller can dynamically adjust the session synchronization from the first network device to the second network device according to a session update rate of the first network device. In one embodiment, the session database and the session synchronization controller can be computer-executable modules residing on a computer-readable medium.

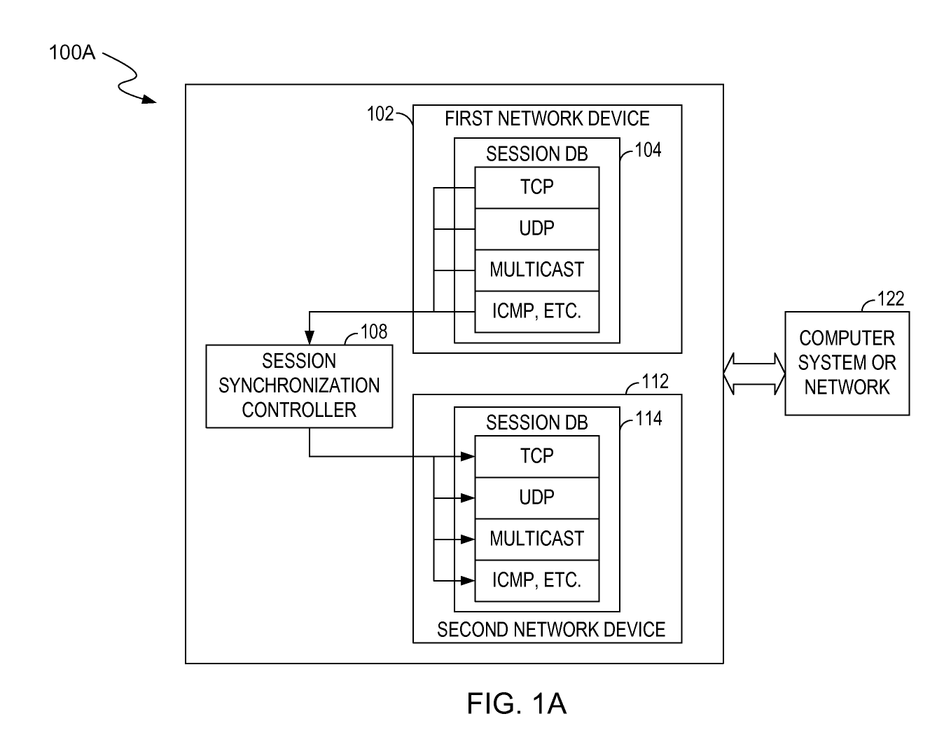

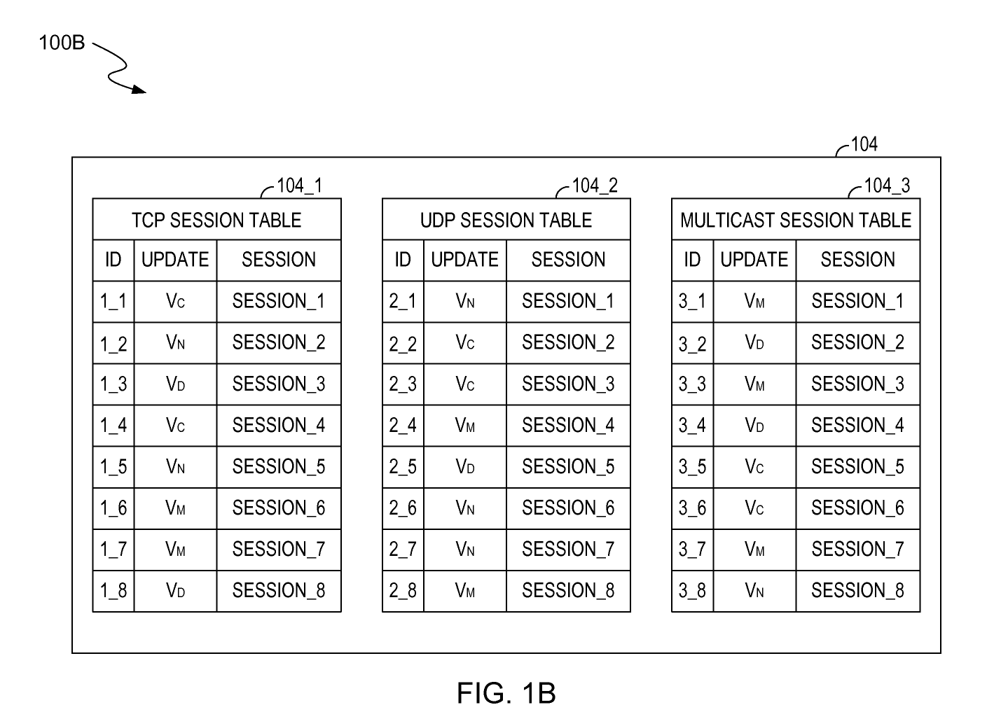

FIG. 1A illustrates a block diagram of a system 100A with dynamic session synchronization, in accordance with one embodiment of the present invention. The system 100A includes a first network device 102, a second network device 112, and a session synchronization controller 108. The first network device 102 can function as a master and the second network device 112 can function as a backup of the first network device, in one embodiment. By way of example, each of the network devices 102 and 112 can include a router. Alternatively, each of the network devices 102 and 112 can include a firewall.

When the system 100A starts to work, the first network device 102 can be enabled to perform its designed functions. For example, if the first network device 102 is a firewall, the first network device can function to prevent unauthorized electronic access to a computer system or a router. The first network device 102 can establish sessions in a session database 104. A session indicates an interactive information exchange, e.g., a conversation or a dialogue, between two or more communicating devices. In this embodiment, the sessions established in the session database 104 indicate the interactive information exchanges between the first network device 102 and one or more network devices, e.g., a computer or a router, in communication with the first network device 102. The sessions can be established at a certain time in the session database 104 and modified or torn down at a later time, in one embodiment. The sessions can be classified into several types including, but are not limited to, transmission control protocol (TCP) sessions, user datagram protocol (UDP) sessions, internet control message protocol (ICMP) sessions, multicast sessions, etc. Additionally, an identification attribute and an update attribute of each session can be stored in the session database 104, in one embodiment.

The identification attribute of a session can be used to identify the session. In one embodiment, the identification attribute of a session can be set to a unique value. As such, the session can be identified according to the unique identification attribute.

The update attribute of a session is configured to indicate a corresponding status of the session. The update attribute can indicate whether a session is newly created, modified, torn down, or has been synchronized from one session database to another, etc. In one embodiment, when a session is newly created during the operation of the first network device 102, the session can be stored in the session database 104 with an identification attribute having a unique value and an update attribute having a value V_{C}. When a session is modified in the session database 104, the update attribute can be changed to a value V_{M}. When a session is torn down or need to be deleted from the session database 104, the update attribute of this session can be changed to a value V_{D}. When a session is synchronized from the session database 104 to the session database 114, the update attribute of the session can be changed to a value V_{N}. As such, the sessions with the update attributes V_{C}, V_{M} or V_{D} stored in the session database 104 indicates that the sessions have not been synchronized from the session database 104 to the session database 114, while the sessions with the update attribute V_{N} stored in the session database 104 indicates that the sessions have been synchronized from the session database 104 to the session database 114, in one embodiment.

If the first network device 102 becomes unavailable, for example, due to a work failure/error, scheduled down-time, or an abnormal termination, the system 100A can automatically offload tasks from the first network device 102 to the second network device 112, and enable the second network device 112 to provide similar functions instead of the first network device 102 (failover mode). The sessions in the session database 114 are the replications of the sessions in the session database 104, in one embodiment.

During the operation of the first network device, the session synchronization controller 108 synchronize the sessions in the session database 104 into the session database 114 (session synchronization) according to a session update rate of the first network device 102. The session update rate of the first network device 102 indicates the number of sessions updated in the session database 104 during a certain period, e.g., the total number of sessions created or modified in session database 104, or deleted from the session database 104 during a certain period. In one embodiment, the session synchronization controller 108 can select updated sessions, e.g., sessions with the update attributes V_{C}, V_{M} or V_{D}, in the session database 104 based on the priorities of the sessions according to the session update rate of the first network device 102, and synchronize the selected sessions from the session database 104 to the session database 114 according to the update information. In one embodiment, the update information can include, but is not limited to, the identification attributes and the update attributes V_{C}, V_{M} or V_{D} of the selected sessions. Furthermore, the priorities of the sessions can be determined according to the types of the sessions. By way of example, the priorities of the TCP sessions, the UDP sessions, the multicast sessions and the other sessions can conform to a descending order. However, the priorities of the sessions are not limited to the examples described above and can be determined by the users.

In one embodiment, the session synchronization controller 108 can select one or more types from a plurality of session types according to the session update rate of the first network device 102, and then select the sessions with the selected types from the session database 104. Subsequently, the session synchronization controller 108 can synchronize the selected sessions into the session database 114. As such, the type and number of the selected sessions can be adjusted dynamically according to the session update rate of the first network device 102, in one embodiment.

In one embodiment, the session synchronization controller 108 compares the session update rate of the first network device 102 with one or more predetermined thresholds and select sessions with types selected according to the comparison from the session database 104. By way of example, if the session update rate of the first network device 102 is higher than a first predetermined threshold, e.g., 30000 sessions/s, the session synchronization controller 108 can select the TCP sessions from the session database 104. If the session update rate of the first network device 102 is lower than the first predetermined threshold but higher than a second predetermined threshold, e.g., 20000 sessions/s, the session synchronization controller 108 can select the TCP sessions and the UDP sessions from the session database 104. If the session update rate of the first network device 102 is lower than the second predetermined threshold but higher than a third predetermined threshold, e.g., 10000 sessions/s, the session synchronization controller 108 can select the TCP sessions, the UDP sessions and the multicast sessions from the session database 104. If the session update rate of the first network device 102 is lower than the third predetermined threshold, the session synchronization controller 108 can select the TCP sessions, the UDP sessions, the multicast sessions and all the other sessions from the session database 104.

However, the predetermined thresholds and which type of the sessions can be selected according to the comparison between the session update rate and the predetermined thresholds are not limited to the examples described above and can vary according to different system throughput capabilities.

In one embodiment, the sessions can be stored in a corresponding session table in the session database 104 according to the session type, e.g., TCP, UDP, multicast, ICMP, etc. For example, the TCP sessions can be stored in a TCP session table; the UDP sessions can be stored in a UDP session table; the multicast sessions can be stored in a multicast session table; and the ICMP sessions can be stored in an ICMP session table. Similarly, the identification attribute and the update attribute of each session can be stored with each session in the corresponding session table, in one embodiment. The number of the session tables and the session types are not limited to the examples described above and can be varied in different applications.

FIG. 1B shows examples 100B of the session tables in the session database 104 and the sessions stored in the session tables, in accordance with one embodiment of the present invention. In the examples 100B of FIG. 1B, the session database 104 includes, a TCP session table 104_1, a UDP session table 104_2, and a multicast session table 104_3. A session table includes contents of different sessions, the identification attributes and update attributes of the corresponding sessions.

As described in relation to FIG. 1A, the session synchronization controller 108 can select the session types by comparing the session update rate of the first network device 102 with one or more predetermined thresholds, in one embodiment. In the examples 100B of FIG. 1B, the session synchronization controller 108 can select one or more session tables by comparing the session update rate of the first network device 102 with one or more predetermined thresholds.

By way of example, if the session update rate of the first network device 102 is higher than a first predetermined threshold, the session synchronization controller 108 can select the TCP session table 104_1 from the session database 104. If the session update rate of the first network device 102 is lower than the first predetermined threshold but higher than a second predetermined threshold, the session synchronization controller 108 can select the TCP session table 104_1 and the UDP session table 104_2 from the session database 104. If the session update rate of the first network device 102 is lower than the second predetermined threshold but higher than a third predetermined threshold, the session synchronization controller 108 can select the TCP session table 104_1, the UDP session table 104_2 and the multicast session table 104_3 from the session database 104.

Once the session tables are selected, the session synchronization controller 108 can further select the sessions with the update attributes V_{C}, V_{M} or V_{D} in the selected session table(s), and synchronize the selected sessions from the session database 104 to the session database 114 according to the identification attributes and the update attributes of the selected sessions. Moreover, the session synchronization controller 108 can delete the selected sessions with the update attribute V_{D} from the corresponding session tables and change the update attributes of the rest of the selected sessions to value V_{N} in the corresponding session tables.

In one embodiment, if the update attribute of a selected session in the session database 104 has the value V_{C}, the session synchronization controller 108 can store the replication of this session with the same identification attribute in the session database 114. If the update attribute of a selected session in the session database 104 has the value V_{M}, the session synchronization controller 108 can look up a corresponding session in the session database 114 with the same identification attribute, and modify the corresponding session accordingly. If no session with the same identification attribute is found in the session database 114, the session synchronization controller 108 can store the replication of this session with the same identification attribute in the session database 114. If the update attribute of a selected session in the session database 104 has the value V_{D}, the session synchronization controller 108 can look up the corresponding session in the session database 114 with the same identification attribute, and delete the corresponding session from the session database 114.

By way of example, if the TCP session table 104_1 and the UDP session table 104_2 are selected according to the session update rate of the first network device 102, the session synchronization controller 108 can select sessions with the update attributes V_{C}, V_{M} or V_{D}, that is, session_1, session_3, session_4, session_6, session_7, and session_8, from the TCP session table 104_1, and select sessions with the update attributes V_{C}, V_{M} or V_{D}, that is, session_2, session_3, session_4, session_5, session_8 from the UDP session table 104_2. The session synchronization controller 108 can synchronize the selected sessions into the session database 114.

Furthermore, the session synchronization controller 108 can delete the selected sessions with the update attribute V_{D}, that is, session_3 and session_8, from the TCP session table 104_1 and delete the selected sessions with the update attribute V_{D}, that is, session_5, from the UDP session table 104_2. Additionally, the session synchronization controller 108 changes the update attributes of the session_1, session_4, session_6, and session_7 in the TCP session table 104_1 to value V_{N}, and changes the update attributes of the session_2, session_3, session_4, and session_8 in the UDP session table 104_2 to value V_{N}.

If the first network device 102 becomes unavailable, for example, due to a work failure/error, scheduled down-time, or an abnormal termination, a failover mode occurs and the system 100A can offload tasks from the first network device 102 to the second network device 112 and enable the second network device 112 to provide corresponding functions instead of the first network device 102. When the second network device 112 starts to operate instead of the first network device 102, the session synchronization controller 108 can be used for controlling session synchronization from the session database 114 to the session database 104.

Advantageously, the session synchronization can be adjusted dynamically according to the session update rate. When a session update rate is relatively high, a first set of sessions with relatively high priorities, e.g., the TCP sessions, can be synchronized from one session database to another, e.g., from the session database 104 to the session database 114. When the session update rate is relatively low, resources may be used to synchronize other sessions, e.g., the UDP and multicast sessions in addition to the TCP sessions, in one embodiment. Thus, the efficiency of the session synchronization between the session database 104 and the session database 114 can be improved.

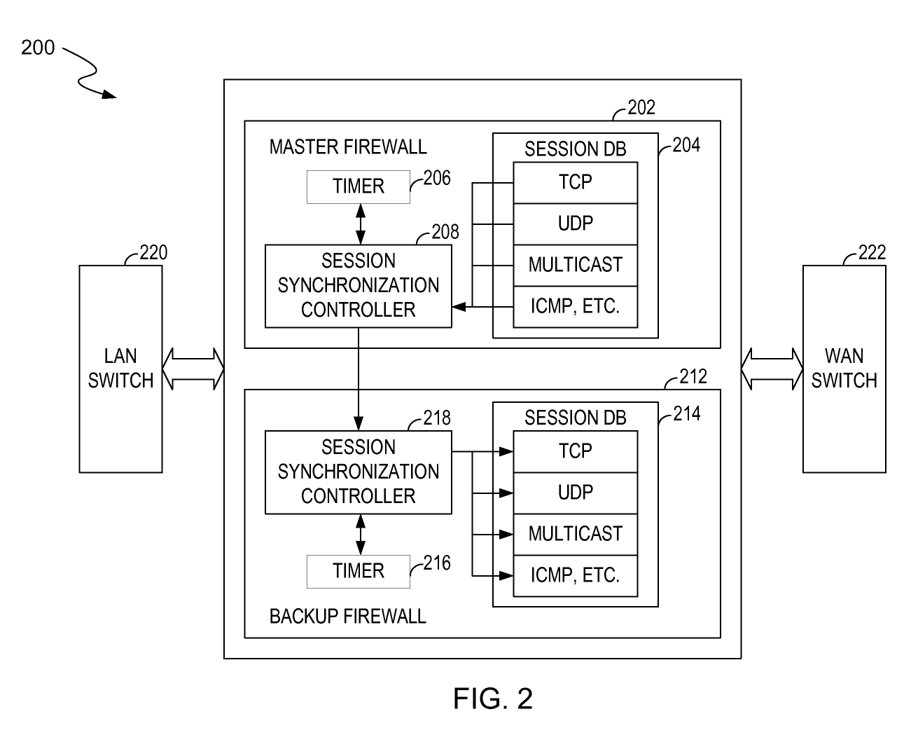

FIG. 2 illustrates a block diagram of a master-backup firewall system 200 with dynamic session synchronization, in accordance with one embodiment of the present invention. Elements labeled the same in FIG. 1A have similar functions. FIG. 2 is described in combination with FIG. 1A.

In one embodiment, the master-backup firewall system 200 includes a master firewall 202 and a backup firewall 212. When the master-backup firewall system 200 starts up, the master firewall 202 can be enabled to block unauthorized access into a network, e.g., a local area network or a wide area network, but permit authorized communications with the network. During the operation of the master firewall 202, the sessions established in the master firewall 202 can be synchronized into the backup firewall 212 (session synchronization). If the master firewall 202 becomes unavailable through a work failure/error, scheduled down-time, or an abnormal termination, the master-backup firewall system 200 can automatically offload tasks from the master firewall 202 to the backup firewall 212 and enable the backup firewall 212 to provide the firewall functions instead of the master firewall 202.

In one embodiment, the master firewall 202 includes a session database 204 for storing various types of sessions such as described in relation to FIG. 1A. The master firewall 202 further includes a session synchronization controller 208 for controlling session synchronization from the master firewall 202 to the backup firewall 212 according to a session update rate of the master firewall 202. More specifically, the session synchronization controller 208 can select sessions updated in the session database 204 and synchronize the selected sessions into the backup firewall 212. As described in relation to FIG. 1A, the updated sessions can include the sessions created, modified or torn down in the session database 204. The type and number of the selected sessions can be adjusted dynamically according to the session update rate of the master firewall 202.

In one embodiment, the backup firewall 212 includes a session database 214 for backing up the sessions from the session database 204. The backup firewall 212 further includes a session synchronization controller 218 for receiving the replications of the selected sessions from the session synchronization controller 208 and update the sessions in the session database 214.

In one embodiment, the master firewall 202 can be enabled to provide the firewall functions between a local area network (LAN) switch 220 and a wide area network (WAN) switch 222. During the operation, the session synchronization controller 208 can select sessions with the update attributes V_{C}, V_{M}, or V_{D} in the session database 204 based on the priorities of the sessions according to the session update rate of the master firewall 202, and send the replications of the selected sessions with the update information to the backup firewall 212 for session synchronization. In one embodiment, the update information can include, but is not limited to, the identification attributes and the update attributes V_{C}, V_{M} or V_{D} of the selected sessions. As described in relation to FIG. 1A, the priorities of the sessions can be determined according to the types of the sessions, in one embodiment. By way of example, the priorities of the TCP sessions, the UDP sessions, the multicast sessions and the other sessions can conform to a descending order.

In one embodiment, the session synchronization controller 208 can periodically check the session update rate of the master firewall 202 and determine the types of sessions to be selected according to the session update rate of the master firewall 202. For example, the session synchronization controller 208 can select one or more session tables in the session database 204 according to the session update rate of the master firewall 202. Once the types of the sessions to be selected are determined (e.g., once the session tables are selected), the session synchronization controller 208 can further select the sessions with the update attributes V_{C}, V_{M}, or V_{D} in the selected session table(s), and send replications of the selected sessions with the corresponding identification attributes and update attributes to the session synchronization controller 218. Accordingly, the session synchronization controller 218 can update the corresponding sessions in the session database 214 according to the identification attributes and the update attributes of the selected sessions. In addition, the session synchronization controller 208 can delete the selected sessions with the update attribute V_{D} from the session database 204, and change the update attributes of the rest of the selected sessions to the value V_{N} in the session database 204.

If the master firewall 202 becomes unavailable through a work failure/error, scheduled down-time, or an abnormal termination, etc., a failover mode occurs. During the failover mode, the master-backup firewall system 200 can offload tasks from the master firewall 202 to the backup firewall 212. Steps of offloading tasks from the master firewall 202 to the backup firewall 212 include synchronizing the sessions from the session database 204 to the session database 214, in one embodiment. A timer 206 can be triggered when the failover mode occurs, in one embodiment. The session synchronization controller 208 can synchronize the sessions from the master firewall 202 to the backup firewall 212 according to the priorities of the sessions until the passed time from the beginning of the failover mode reaches a predetermined maximal time.

In one embodiment, the session synchronization controller 208 can first select a set of unsynchronized sessions with the highest priority from the session database 204. The unsynchronized sessions can include the sessions which have not been synchronized from the master firewall 202 to the backup firewall 212, e.g., the sessions with the update attributes V_{C}, V_{M}, or V_{D}. The session synchronization controller 208 can send the replications of the selected sessions with the corresponding identification attributes and update attributes to the session synchronization controller 218. Accordingly, the session synchronization controller 218 can update the sessions in the session database 214 according to the identification attributes and the update attributes of the selected sessions. As such, the sessions with the highest priority can be synchronized from the master firewall 202 to the backup firewall 212.

After the sessions with the highest priority are synchronized from the master firewall 202 to the backup firewall 212, if the passed time from the beginning of the failover mode still does not reach the predetermined maximal time, the session synchronization controller 208 can select a set of unsynchronized sessions with a next priority from the session database 204. Similarly, the selected sessions can be synchronized from the master firewall 202 to the backup firewall 212.

The session synchronization controller 208 can continue to synchronize the sessions from the master firewall 202 to the backup firewall 212 according to the priorities of the sessions until the passed time from the beginning of the failover mode reaches the predetermined maximal time.

In one embodiment, the priorities of the sessions can be determined according to the types of the sessions. By way of example, the priorities of the TCP sessions, the UDP sessions, the multicast sessions and the other sessions can conform to a descending order. As such, when the failover mode occurs, the session synchronization controller 208 can select a session table with the highest priority from the session database 204, e.g., the TCP session table. The session synchronization controller 208 can select the sessions with the update attributes V_{C}, V_{M}, or V_{D} in the selected session table, and send the replications of the selected sessions with the corresponding identification attributes and update attributes to the session synchronization controller 218. Accordingly, the session synchronization controller 218 can update the sessions in the session database 214 according to the identification attributes and the update attributes of the selected sessions. As such, the sessions in the selected session table can be synchronized from the master firewall 202 to the backup firewall 212.

After the selected sessions with the highest priority are synchronized from the master firewall 202 to the backup firewall 212, if the passed time from the beginning of the failover mode still does not reach the predetermined maximal time, the session synchronization controller 208 can select another session table with a next priority from the session database 204, e.g., the UDP session table. Similarly, the sessions with the update attributes V_{C}, V_{M}, or V_{D} in the selected session table can be synchronized from the master firewall 202 to the backup firewall 212.

The session synchronization controller 208 can continue to select other session tables according to priorities of the session types from the master firewall 202 and synchronize sessions with the update attributes V_{C}, V_{M}, or V_{D} in the selected session tables from the master firewall 202 to the backup firewall 212 until the passed time from the beginning of the failover mode reaches the predetermined maximal time.

When the passed time from the beginning of the failover mode reaches the predetermined maximal time, the master-backup firewall system 200 can enable the backup firewall 212 to provide the firewall functions instead of the master firewall 202. As such, the master-backup firewall system 200 can utilize the available resources more efficiently to synchronize the sessions.

When the backup firewall 212 starts to operate instead of the master firewall 202, the session synchronization controller 218 can be used for controlling session synchronization from the backup firewall 212 to the master firewall 202. Similarly, the session synchronization controller 208 can be used to synchronize the sessions from the session database 214 to the session database 204 according to a session update rate of the backup firewall 212. A timer 216 can be triggered when the backup firewall 212 becomes unavailable. As such, dynamic session synchronization from the backup firewall 212 to the master firewall 202 can also be achieved. Although the invention is described in the context of a system including a master firewall and a backup firewall, the invention is not so limited; it can also be used in master-backup firewall systems including more than two firewalls.

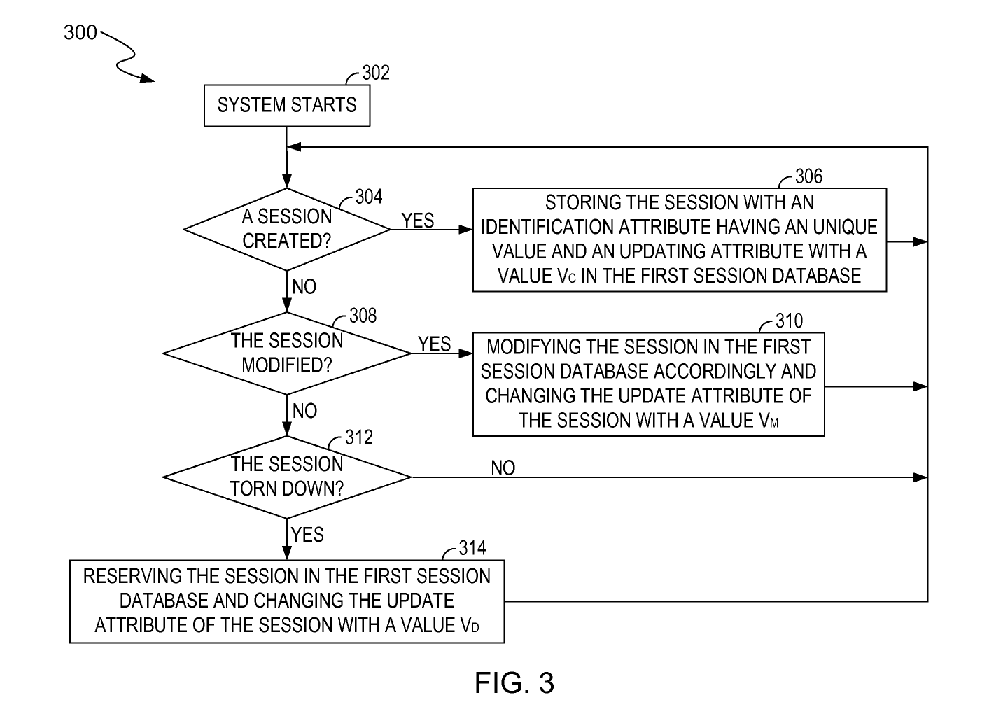

FIG. 3 illustrates a flowchart 300 of a method for establishing and updating sessions in a first session database, e.g., the session database 104 in FIG. 1A or the session database 204 in FIG. 2, in accordance with one embodiment of the present invention. FIG. 3 is described in combination with FIG. 1A. Although specific steps are disclosed in FIG. 3, such steps are examples. That is, the present invention is well suited to perform various other steps or variations of the steps recited in FIG. 3. In one embodiment, a computer-readable medium having stored therein computer-executable instructions that, if executed by a computer system, cause the computer system to execute a method shown in flowchart 300.

In block 302, the system starts to operate and multiple sessions are established. In block 304, if a session is created, the session can be stored with an identification attribute having a unique value and an update attribute having a value V_{C} in the corresponding session table of the first session database according to the session type (block 306). Otherwise, the flowchart 300 goes to block 308. By way of example, a TCP session can be stored in a TCP session table; a UDP session can be stored in a UDP session table; a multicast session can be stored in a multicast session table; and an ICMP session or a session with other type can be stored in a corresponding session table.

In block 308, if the session is modified during the operation, the session can be modified in the first session database accordingly, and the update attribute of this session can be changed to the value V_{M} in block 310. Otherwise, the flowchart 300 goes to block 312.

In block 312, if a session is torn down, the flowchart 300 goes to block 314. Otherwise, the flowchart 300 returns to block 304. In block 314, the session can be reserved in the first session database for session synchronization and the update attribute of this session can be changed to the value V_{D}.

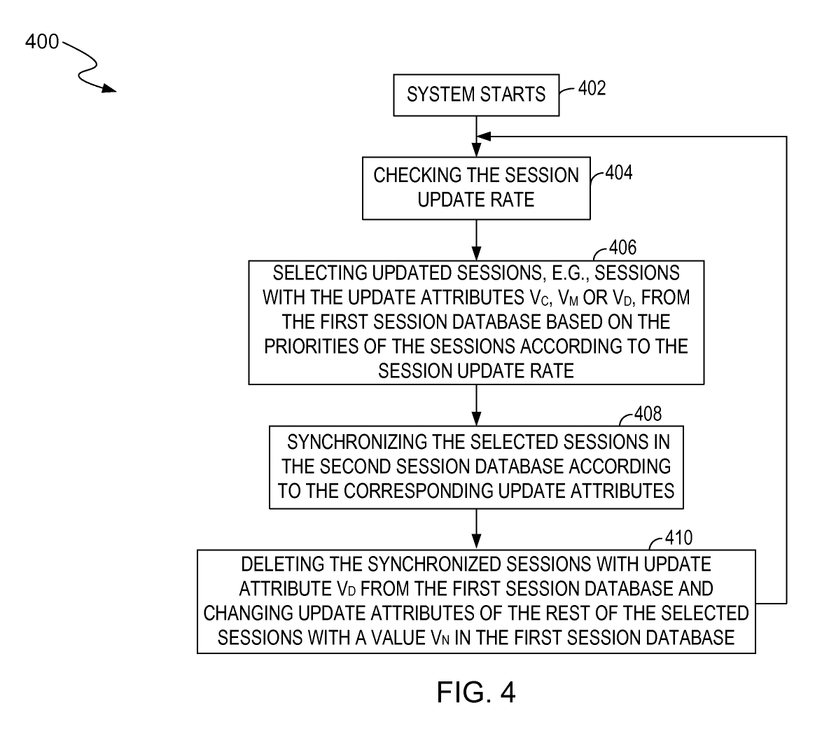

FIG. 4 illustrates a flowchart 400 of a method for synchronizing sessions from a first session database to a second session database, e.g., from the session database 104 to the session database 114 in FIG. 1A, in accordance with one embodiment of the present invention. FIG. 4 is described in combination with FIG. 1A, FIG. 1B and FIG. 3. Although specific steps are disclosed in FIG. 4, such steps are examples. That is, the present invention is well suited to perform various other steps or variations of the steps recited in FIG. 4. In one embodiment, a computer-readable medium having stored therein computer-executable instructions that, if executed by a computer system, cause the computer system to execute a method shown in flowchart 400.

In block 402, the system 100A starts to work. In block 404, the session synchronization controller 108 checks the session update rate of the first network device 102. In block 406, the session synchronization controller 108 can select updated sessions, e.g., sessions with the update attributes V_{C}, V_{M} or V_{D}, from the first session database, e.g., the session database 104, based on the priorities of the sessions according to the session update rate of the first network device 102.

In one embodiment, the session synchronization controller 108 determines the types of sessions to be selected according to the session update rate of the first network device 102. For example, the session synchronization controller 108 can select one or more session tables in the session database 104 according to the session update rate of the first network device 102. Once the types of the sessions to be selected are determined (e.g., once the session tables are selected), the session synchronization controller 108 can further select the sessions with the update attributes V_{C}, V_{M}, or V_{D} and the identification attributes from the selected session table(s).

In block 408, the session synchronization controller 108 can synchronize the selected sessions in the second session database, e.g., the session database 114, according to the corresponding update attributes.

In one embodiment, if the update attribute of a session is the value V_{C}, the session synchronization controller 108 can store the replication of this session with the same identification attribute in the session database 114. If the update attribute of a session is the value V_{M}, the session synchronization controller 108 can look up a corresponding session in the session database 114 with the same identification attribute and modify the corresponding session according to the current session. If no session with the same identification attribute is found in the session database 114, the session synchronization controller 108 can store the replication of this session with the identification attribute in the session database 114. If the update attribute of a session is the value V_{D}, the session synchronization controller 108 can look up the corresponding session in the session database 114 with the same identification attribute, and delete the corresponding session from the session database 114.

In block 410, the session synchronization controller 108 can delete the synchronized sessions with the update attribute V_{D} from the session database 104, and change the update attributes of the rest of the selected sessions to the value V_{N} in the session database 104.

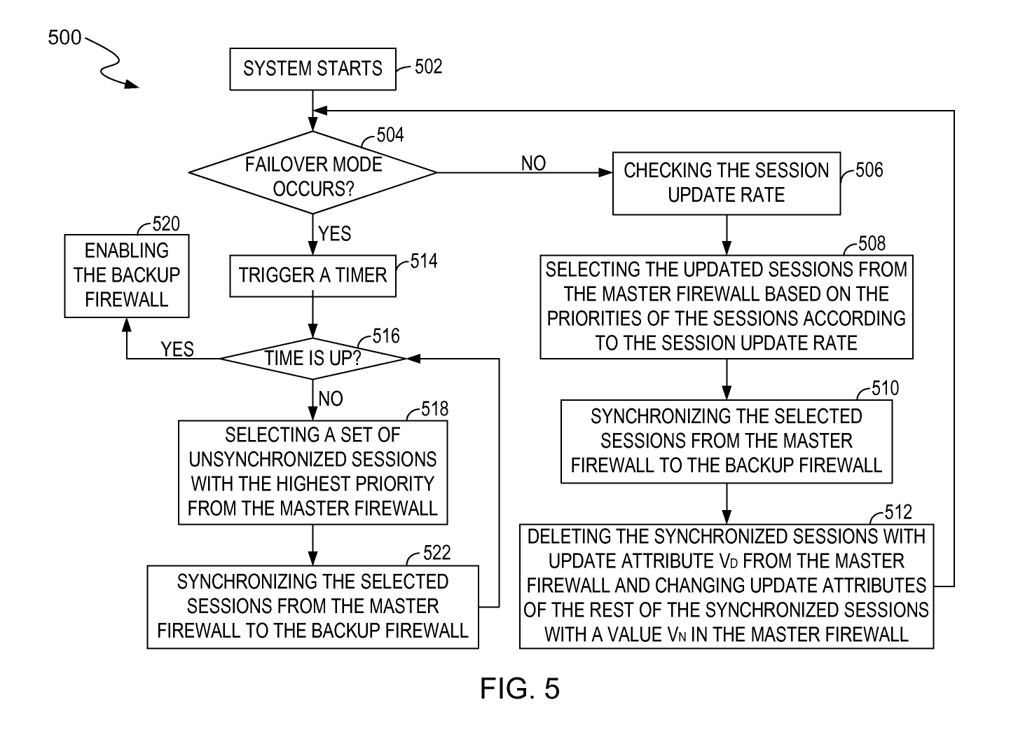

FIG. 5 illustrates a flowchart 500 of a method for synchronizing sessions from a master firewall to a backup firewall in a master-backup firewall system, e.g., the master-backup firewall system 200 in FIG. 2, in accordance with one embodiment of the present invention. FIG. 5 is described in combination with FIG. 1A, FIG. 2 and FIG. 3. Although specific steps are disclosed in FIG. 5, such steps are examples. That is, the present invention is well suited to perform various other steps or variations of the steps recited in FIG. 5. In one embodiment, a computer-readable medium having stored therein computer-executable instructions that, if executed by a computer system, cause the computer system to execute a method shown in flowchart 500.

In block 502, the master-backup firewall system 200 enables the master firewall 202 to provide firewall functions between a LAN switch 220 and a WAN switch 222. The backup firewall 212 can backup the sessions of the master firewall 202 during the operation of the master firewall 202.

In block 504, the master-backup firewall system 200 can check whether a failover occurs. If there is no failover, which indicates the master firewall 202 is available to provide the firewall functions, the flowchart 500 goes to block 506. Otherwise, the flowchart 500 goes to block 514. In block 506, the session synchronization controller 208 can check the session update rate of the master firewall 202. In block 508, the session synchronization controller 208 can select updated sessions, e.g., sessions with the update attributes V_{C}, V_{M} or V_{D}, from the master firewall 202 based on the priorities of the sessions according to the session update rate of the master firewall 202. More specifically, the session synchronization controller 208 selects the updated sessions from the first session database, e.g., the session database 204 of the master firewall 202.

In one embodiment, the session synchronization controller 208 determines the types of sessions to be selected according to the session update rate of the master firewall 202. For example, the session synchronization controller 208 can select one or more session tables in the session database 204 according to the session update rate of the master firewall 202. Once the types of the sessions to be selected are determined (e.g., once the session tables are selected), the session synchronization controller 208 can further select the sessions with the update attributes V_{C}, V_{M}, or V_{D} and the identification attributes from the selected session table(s).

In block 510, the selected sessions can be synchronized from the master firewall 202 to the backup firewall 212 according to the corresponding update attributes and identification attributes. In block 512, the session synchronization controller 208 can delete the synchronized sessions with the update attribute V_{D} from the session database 204, and change the update attributes of the rest of the selected sessions to the value V_{N} in the session database 204.

In block 504, if a failover mode occurs, which indicates that the master firewall 202 becomes unavailable, for example, due to a work failure/error, scheduled down-time, or an abnormal termination, the timer 206 can be triggered to count a passed time from the beginning of the failover mode (block 514) and the master-backup firewall system 200 can start to offload tasks from the master firewall 202 to the backup firewall 212. In block 516, if the passed time from the beginning of the failover mode does not reach a predetermined maximal time, the flowchart 500 goes to block 518. In block 518, the session synchronization controller 208 can select a set of unsynchronized sessions with the highest priority from the session database 204 of the master firewall 202. The unsynchronized sessions can include the sessions which have not been synchronized from the master firewall 202 to the backup firewall 212, e.g., the sessions with the update attributes V_{C}, V_{M}, or V_{D}. In block 522, the selected sessions can be synchronized from the master firewall 202 to the backup firewall 212.

After the selected sessions are synchronized from the master firewall 202 to the backup firewall 212 (block 522), if the passed time from the beginning of the failover mode still does not reach the predetermined maximal time (block 516), the session synchronization controller 208 can select a set of unsynchronized sessions with a next priority in the session database 204 for the session synchronization. As such, the session synchronization controller 208 can continue to synchronize the sessions from the master firewall 202 to the backup firewall 212 according to the priorities of the sessions until the passed time from the beginning of the failover mode reaches the predetermined maximal time.

In block 516, if the passed time from the beginning of the failover mode reaches the predetermined maximal time, the master-backup firewall system 200 can enable the backup firewall 212 to provide the firewall functions instead of the master firewall 202 (block 520). Similarly, the sessions from the backup firewall 212 can be synchronized to the master firewall 202.

Accordingly, embodiments in accordance with the present invention provide a network system with dynamic session synchronization. The network system includes a first session database for storing multiple sessions indicating information interchanges between at least two communicating devices, and includes a second session database for backing up the sessions stored in the first session database. The network system further includes a controller operable for selecting a session from the first session database according to a session update rate indicating the number of sessions updated in the first session database during a given period of time and for synchronizing the selected session from the first session database to the second session database. As such, the system can utilize the available resources more efficiently to perform session synchronization.

While the foregoing description and drawings represent embodiments of the present invention, it will be understood that various additions, modifications and substitutions can be made therein without departing from the spirit and scope of the principles of the present invention as defined in the accompanying claims. One skilled in the art will appreciate that the invention can be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A computer-readable medium having computer-executable modules comprising:
a first session database for storing a plurality of sessions indicating information interchange between at least two communicating devices; and
a controller operable for selecting a session from said first session database according to a session update rate indicating the number of sessions updated in said first session database during a given period of time and for synchronizing said session from said first session database to a second session database.

2. The computer-readable medium of claim 1, wherein said controller selects said session from said plurality of sessions stored in said first session database based on priorities of said plurality of sessions.

3. The computer-readable medium of claim 2, wherein said priorities are determined according to types of said plurality of sessions.

4. The computer-readable medium of claim 1, wherein said first session database further stores a plurality of update attributes corresponding to said plurality of sessions, wherein said update attributes are configured to indicate respective statuses of said plurality of sessions.

5. The computer-readable medium of claim 4, wherein said controller selects said session based on a corresponding update attribute from said first session database.

6. The computer-readable medium of claim 4, wherein said controller synchronizes said session from said first session database to said second session database according to a corresponding update attribute.

7. The computer-readable medium of claim 1, wherein said controller compares said session update rate to a plurality of predetermined thresholds, and selects said session from said first session database according to said comparison.

8. The computer-readable medium of claim 1, wherein said controller selects at least one type from types of said plurality of sessions according to said session update rate, and selects said session with said at least one type.

9. A computer system comprising:
A computer-readable medium having stored therein computer-executable instructions that, if executed by said computer system, cause said computer system to execute a method, said method comprising:
storing a plurality of sessions indicating information interchange between at least two communicating devices in a first session database;
selecting a session from said first session database according to a session update rate indicating the number of sessions updated in said first session database during a given period of time; and
synchronizing said session from said first session database to a second session database.

10. The computer system of claim 9, wherein said method further comprises:
selecting said session from said plurality of sessions stored in said first session database based on priorities of said plurality of sessions.

11. The computer system of claim 10, wherein said method further comprises:
determining said priorities according to types of said plurality of sessions.

12. The computer system of claim 9, wherein said method further comprises:
storing a plurality of update attributes corresponding to said plurality of sessions in said first session database, wherein said update attributes are configured to indicate respective statuses of said plurality of sessions.

13. The computer system of claim 12, wherein said method further comprises:
selecting said session based on a corresponding update attribute from said first session database.

14. The computer system of claim 12, wherein said method further comprises:
synchronizing said session from said first session database to said second session database according to a corresponding update attribute.

15. The computer system of claim 9, wherein said method further comprises:
comparing said session update rate to a plurality of predetermined thresholds; and
selecting said session from said first session database according to said comparison.

16. The computer system of claim 9, wherein said method further comprises:
selecting at least one type from a plurality of types of said plurality of sessions according to said session update rate, and selects said session with said at least one type.

17. A network system comprising:
a first network device for storing a plurality of sessions indicating information interchange between said first network device and a communicating device;
a second network device coupled to said first network device and operable for functioning as a backup for said first network device; and
wherein said sessions are synchronized from said first network device to said second network device according to a session update rate indicating the number of sessions updated in said first network device during a given period of time.

18. The network system of claim 17, wherein said first network device comprises a master firewall and wherein said second network device comprises a backup firewall.

19. The network system of claim 17, wherein said first network device selects a session from said plurality of sessions based on priorities of said plurality of sessions according to said session update rate.

20. The network system of claim 19, wherein said priorities are determined according to types of said plurality of sessions.

21. The network system of claim 17, wherein said first network device stores a plurality of update attributes corresponding to said plurality of sessions, wherein said update attributes are configured to indicate respective statuses of said plurality of sessions.

22. The network system of claim 21, wherein said first network device selects said session based on a corresponding update attribute and sends said session with said corresponding update attribute to said second network device.

23. The network system of claim 21, wherein said second network device backs up said session according to a corresponding update attribute.

24. The network system of claim 17, wherein said first network device comprises:
a timer, wherein said timer is triggered when a failover mode of said network system occurs; and
a controller coupled to said timer, wherein said controller synchronizes said sessions from said first network device to said second network device according to priorities of said sessions until the passed time from the beginning of said failover mode reaches a predetermined maximal time.

25. The network system of claim 17, wherein said first network device compares said session update rate to a plurality of predetermined thresholds, and selects said session according to said comparison.
